(19) United States
(12) Patent Application Publication
(10) Pub. No.: US 2012/0239330 A1
(43) Pub. Date: Sep. 20, 2012

(54) RADIOMETRIC CALIBRATION METHOD FOR INFRARED DETECTORS

(76) Inventors: Pierre Tremblay, L'Ancienne-Lorette (CA); Louis Belhumeur, Quebec (CA); Martin Chamberland, L'Ancienne-Lorette (CA); André Villemaire, Quebec (CA)

(21) Appl. No.: 13/512,961

(22) PCT Filed: Dec. 7, 2010
(86) PCT No.: PCT/IB2010/055646

§ 371 Date: May 31, 2012

Related U.S. Application Data
(60) Provisional application No. 61/295,959, filed on Jan. 18, 2010.

(51) Int. Cl. G06F 19/00

(52) U.S. Cl. 702/85

(57) ABSTRACT

A method for radiometric calibration of an infrared detector, the infrared detector measuring a radiance received from a scene under observation, the method comprising: providing calculated calibration coefficients; acquiring a scene count of the radiance detected from the scene; calculating a scene flux from the scene count using the calculated calibration coefficients; determining and applying a gain-offset correction using the calculated calibration coefficients to obtain a uniform scene flux. In one embodiment, the method further includes transforming the uniform scene flux to a radiometric temperature using the calculated calibration coefficients.

### CROSS-REFERENCE TO RELATED APPLICATIONS

The present application claims priority benefit on U.S. provisional patent application No. 61/295,959 filed Jan. 18, 2010, the specification of which is hereby incorporated by reference.

### TECHNICAL FIELD

The invention relates to radiometric calibration of infrared detectors, more particularly when the infrared detectors are operated in the integrating mode.

### BACKGROUND OF THE ART

Infrared (IR) detectors are less ubiquitous than cameras operating in the visible range (such as CCD and CMOS), but their use is becoming more widespread as the price of IR technology is decreasing. Infrared imagery enables to meet the requirements of specialized applications that cannot be met by a standard visible camera such as night vision, thermography and non-destructive testing. Another factor helping the dissemination of the IR technology is the ease of use that is featured by new detectors being introduced to the market.

One difficulty with infrared detectors stems from the fact that the semiconductor materials used in the infrared focal plane arrays (FPA) is less mature and much less uniform than the Silicon used in visible range cameras. Spatial nonuniformities in the photo-response of individual pixels can lead to unusable images in their untreated state. Nonuniformity correction (NUC) have been devised in the prior art to address this limitation and to produce corrected images that provide more valuable and useable information. Modern IR detectors feature built-in hardware and automation to allow NUC to be performed with little user intervention.

There is a need, especially for high-end and scientific thermal infrared detectors, to produce absolutely calibrated images in units of temperature or radiance, rather than just non-uniformity corrected images. Ideally this calibration correction would be performed in real-time and also with as little user intervention as possible.

The prior art systems and method for calibrating infrared detectors therefore have many drawbacks and there is a need for an improved calibration method.

### SUMMARY

Considering the newly available infrared focal plane arrays (FPA) exhibiting very high spatial resolution and faster readout speed (faster read speed along tailored spectral bands), a method is described and provides a dedicated radiometric calibration of every (valid) pixel. The novel approach is based on detected fluxes rather than detected counts as is customarily done in the prior art. This approach allows the explicit management of the main parameter used to change the gain of the detector, namely the exposure time. The method can handle the spatial variation of detector spectral responsivity across the FPA pixels and can also provide an efficient way to correct for the change of signal offset due to camera self-emission (such as contributions from spectral filters, neutral filters, foreoptics, optical relay) and detector dark current. It can tackle spatial and temporal variations of the intrinsic charge accumulation mechanisms such as sensor self-emission. The method can encompass the effects of biasing the accumulated charge during integration, as well as electronic offsets. The method can have only a few parameters to enable a real-time implementation for megapixel-FPAs and for data throughputs larger than 100 Mpixels/s.

A method for radiometric calibration of an infrared detector is provided. The infrared detector measures a radiance received from a scene under observation. The method comprises providing calculated calibration coefficients; acquiring a scene count of the radiance detected from the scene; calculating a scene flux from the scene count using the calculated calibration coefficients; determining an offset correction using the calculated calibration coefficients; radiometrically correcting the scene flux using the gain-offset correction and the calculated calibration coefficients.

According to one broad aspect of the present invention, there is provided a radiometric calibration method for every focal plane array (FPA) pixel of an infrared detector, comprising: accounting for the spatially varying spectral responsivity across said FPA pixels; enabling to tackle spatial and temporal variations of the intrinsic charge accumulation mechanism of said infrared detector; encompassing the effects of biasing the accumulated charge during integration of said infrared detector.

In one embodiment, the intrinsic charge accumulation mechanism is at least one of sensor self-emission and detector dark current of said detector.

In one embodiment, the effects to encompass are electronic offsets and the self-emission of the camera optics which comes from windows, lenses, spectral filters, neutral filters, holders, etc.

According to another broad aspect of the present invention, there is provided a method for radiometric calibration of an infrared detector. The infrared detector measures a radiance received from a scene under observation. The method comprises: providing calculated calibration coefficients; acquiring a scene count of the radiance detected from the scene; calculating a scene flux from the scene count using the calculated calibration coefficients; determining and applying a gain-offset correction using the calculated calibration coefficients to obtain a uniform scene flux.

In one embodiment, the method further includes transforming the uniform scene flux to a radiometric temperature using the calculated calibration coefficients.

### BRIEF DESCRIPTION OF THE DRAWINGS

Reference will now be made to the accompanying drawings, showing by way of illustration a preferred embodiment thereof and in which

FIG. 1 shows an example infrared camera;

FIG. 2 is a representation of the detector signal C in counts as a function of the integration time tᵢₙₜ.;

FIG. 3 is a representation of the detector signal C in counts as a function of the integration time tᵢₙₜ. with the presentation of t_{off}. the integration time offset;

FIG. 4 is a representation of the photon flux F in counts per second as a function of the scene temperature;

FIG. 5 shows a simplified diagram of radiometric calibration process;

FIG. 6 shows a (T, F) datum which can be placed on the F graph of FIG. 4;

FIG. 7 shows a detailed diagram of radiometric calibration process;

FIG. 8 shows Instrument response function R(σ);

FIG. 9 shows the relationship between instrument internal flux and instrument temperature;

FIG. 10 shows a prior art calibration method;

FIG. 11 shows a simplified embodiment of the described method;

FIG. 12 shows the determination of the nominal flux curve F(T) for a 3 μm-5 μm infrared camera for blackbody temperatures from 10° C. to 100° C. for an example experimental result;

FIG. 13 shows the uncertainty graph for FIG. 12;

FIG. 14, which comprises FIG. 14A to FIG. 14O, shows examples of single-pixel fits obtained for 15 randomly selected good pixels, for a 3 μm-5 μm infrared camera for the example experimental result;

FIG. 15, which includes FIG. 15A to FIG. 15E, shows histograms of the fitted α and β coefficients and the corresponding fitting uncertainties as well as the fit residuals for all good pixels of the example experiment result;

FIG. 16, which comprises FIG. 16A to FIG. 16F, shows the measured radiometric temperature of a blackbody set at 30° C., using six different exposure times as indicated above each graph for the example experiment result;

FIG. 17, which comprises FIG. 17A and FIG. 17B which are photographs, shows an image of a golf club just after hitting a golf ball off a tee including the raw uncalibrated image (FIG. 17A) and after applying the calibration process described herein, in units of radiometric temperature (FIG. 17B).

It will be noted that throughout the appended drawings, like features are identified by like reference numerals.

### DETAILED DESCRIPTION

The method described pertains to the radiometric calibration of infrared detectors operated in the integrating mode. As for standard photography cameras, these photodetectors integrate the signal only during the exposure period.

One purpose of the infrared detector is to measure the radiance emitted or reflected by certain scenes or scenes under observation. It is important to note that all objects with a non-zero Kelvin temperature emit infrared radiation. In fact in addition to the signal from scenes of interest, infrared detectors also see the signal emitted by optical lens systems and optical apertures within the instrument.

### Infrared Detector

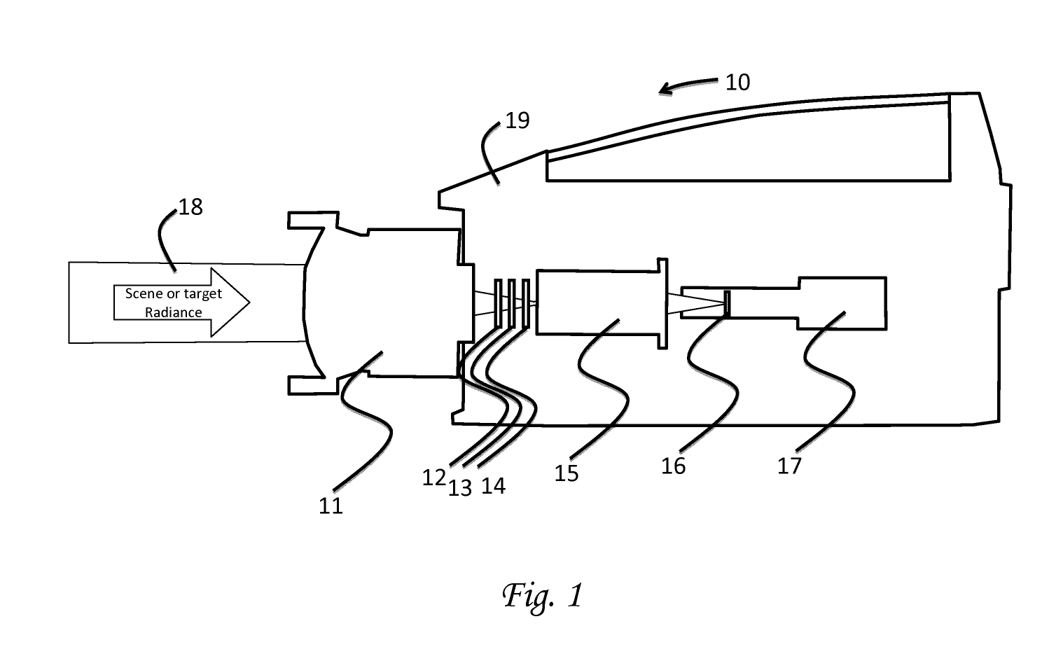

The method described herein is applicable for the calibration of an infrared detector. An example of an infrared camera, which is a specific type of infrared detectors, is shown in FIG. 1. The camera shown in FIG. 1 features an infrared detector array (item 16) housed inside a mechanical cooler (item 17).

An image of the scene is produced on the infrared detector array by a set of infrared lenses composed of items 11 and 15.

It should be noted that in some infrared detectors, there is no lens. In those cases, the infrared detector is not an infrared camera. The method described herein could still be used to calibrate the infrared detector even if it does not have a lens. In most infrared detectors, however, at least one lens will be provided and they will be considered to be infrared cameras.

The foreoptics (item 11) is a standard infinite conjugate infrared lens which produces an image of the scene between item 14 and item 15. Lens assembly 15 is a finite conjugate relay optics used to reimage the scene on the infrared detector array, item 16.

The calibration method described herein is also applicable for camera configurations that omit the relay optics assembly (item 15). The optical configuration with a relay has the benefit making ample space between items 11 and 15 in order to insert optical filters (13 and 14) and a calibration source (12). On the other hand, custom-made infinite conjugate infrared lens with more back-working distance could be used without a relay optics assembly if sufficient space is present to include the items 12 to 14.

The first optical filter item (13) is a set of user-commandable bandpass spectral filters. Each filter is used to select a desired portion of the spectral range in order to gain knowledge of the spectral distribution of the source viewed by the camera or detector. In general these filters are arranged on a rotating wheel to allow rapid cycling between the various filters. It should be understood that other mechanisms allowing to cycle or switch between the various filters could be used.

The second optical filter item (14) is a set of user-commandable neutral density filters. These filters are used to attenuate the signal from hot sources to prevent saturation, when saturation cannot be avoided by reducing the integration time alone. The neutral density filters can be arranged on a wheel or a portion of a wheel, depending on the number of attenuation steps desired. Similarly, another mechanism to allo switching between neutral density filters could be used.

The order of the optical filter items is arbitrary so the neutral density filters could be placed before the bandpass filters.

Finally, item 12 is a radiometric calibration etalon inserted periodically at the position shown in FIG. 1 in order to initiate the calibration process.

### Radiometric Calibration in the Infrared

The process of calibration is to assign physical units to the raw instrument output (counts). The calibration process consists in three steps: a) the acquisition of instrument data using etalons, i.e. sources of known signals such as item 12 of FIG. 1, b) the calculation of calibration coefficients using the etalon data and the appropriate mathematical equations, and c) the application of these coefficients on raw measurements of a scene or scene of interest.

The etalons for radiance in the thermal infrared range, i.e. for wavelengths longer than approximately 3 μm, are principally black body simulators. A black body simulator is an opaque object with a near-perfect absorption coefficient. A perfect black body features a 100% absorbance and emits radiance according only to its temperature as described by the Planck relationship (Equation 1).

$$P ( T ) = \frac{2 c {σ}^{2}}{{e}^{\frac{hc σ}{kT}} - 1} \qquad Equation 1$$

Where P(T) is the photonic spectral radiance [photons/(s sr m² m⁻¹)], h is the Planck constant [Js], c is the speed of light [m/s], σ is the wavenumber [cm−1], k is the Boltzmann constant [J/K] and T is the temperature [K].

An imperfect black body, sometimes known as a grey body (GB), emits radiance according to its temperature as described by the Planck relationship multiplied by a factor ε_{GB}, coined emissivity. An imperfect black body also reflects the radiance from the environment Lₑₙᵥ according to its reflectivity coefficient (1−ε_{GB}) to yield the total radiance as given by Equation 2.

L_{GB}=ε_{GB}·P(T_{GB})+(1−ε_{GB})·Lₑₙᵥ Equation 2

The most natural and most accurate units for a calibrated IR detector measurement are the radiometric temperature, i.e. the temperature that a perfect black body would need to be at to emit the same number of photons that the scene under measurement is contributing, including the emission, transmission and reflection.

### Radiometric Calibration Equations

The simplest method to calibrate a linear instrument is to perform measurements with two etalons and solve for the instrument gain g and offset o. The generic instrument response equation is given by Equation 3.

M=g*L+o Equation 3

Where M is the measurement in counts, L is the spectral radiance integrated over the response function of the instrument in photons/(s sr m² m⁻¹), g is the radiometric gain in counts*sr*m²/W and o is the radiometric offset in counts. The radiance is obtained by integrating over the spectral range of the instrument.

Equation 4 and Equation 5 are obtained from measurements with etalons A and B.

M_{A}=g*L_{A}+o Equation 4

M_{B}=g*L_{B}+o Equation 5

Solving Equation 4 and Equation 5 for gain and offset yields Equation 6 and Equation 7.

g=(M_{A}−M_{B})/(L_{A}−L_{B}) Equation 6

o=M_{A}−g*L_{A} Equation 7

In most cases however, it is impractical to have two black body simulators integrated in the instrument to perform the radiometric calibration. This is especially true for the high temperature blackbodies which tend to be large and tend to require a lot of electrical power.

Rather, it is desirable to use only one black body simulator. In the method described, only one black body simulator is used in the field to measure the instrument offset since it is assumed that the instrument gain is stable and can be characterized infrequently in the laboratory.

### Detector Signal Versus Integration Time

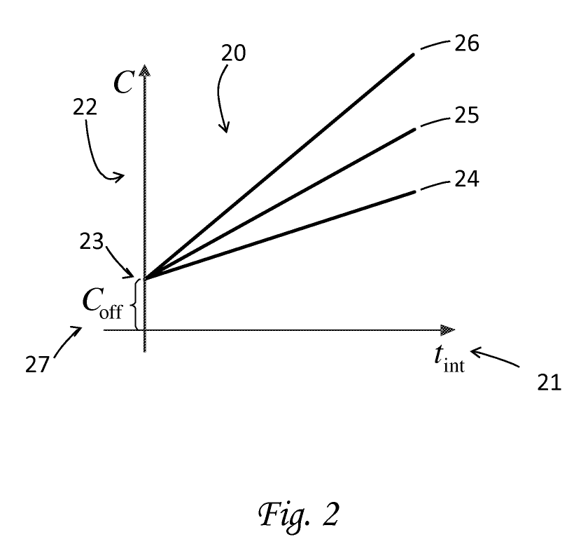

FIG. 2 is a representation of the detector signal C in counts as a function of the integration time tᵢₙₜ. In FIG. 2, the detector is assumed to have a linear integration response, so the described method is applicable where the detector-counts increase linearly with the integration time.

The method can be adapted to a detector exhibiting a non-linear counts-vs.-integration-time relation by characterizing and storing the integration response.

In FIG. 2 the curves are illustrated for three cases with increasing photon fluxes impinging on the detector, for example for increasing scene temperatures.

In theory, all curves intersect at zero integration time as shown in FIG. 2, i.e. where the counts become independent of the photon flux or scene temperature. The count offset C_{off} is the signal obtained when no photons are integrated. C_{off} is principally due to electronic offsets in the readout circuitry.

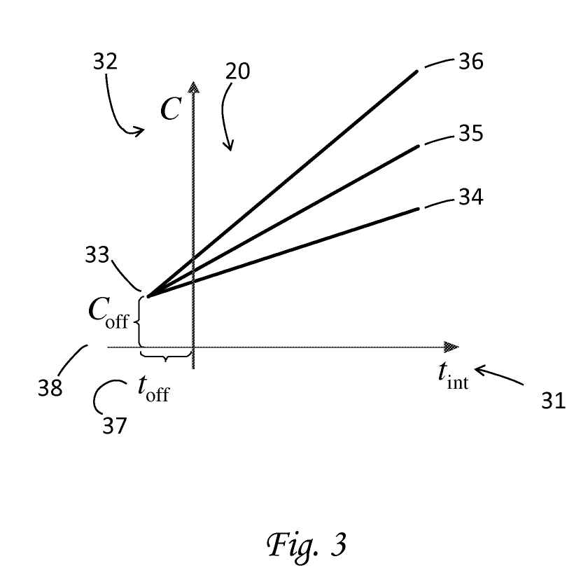

In general, the integration curves do not cross at tᵢₙₜ=0, but rather at a finite tᵢₙₜ=t_{off}, such as the example illustrated in FIG. 3. This t_{off} is characterized using at least two cases with different photon fluxes. If this offset is stable in time, the most convenient method is to evaluate the t_{off} at factory and store this coefficient for later use. Otherwise, it should be evaluated periodically.

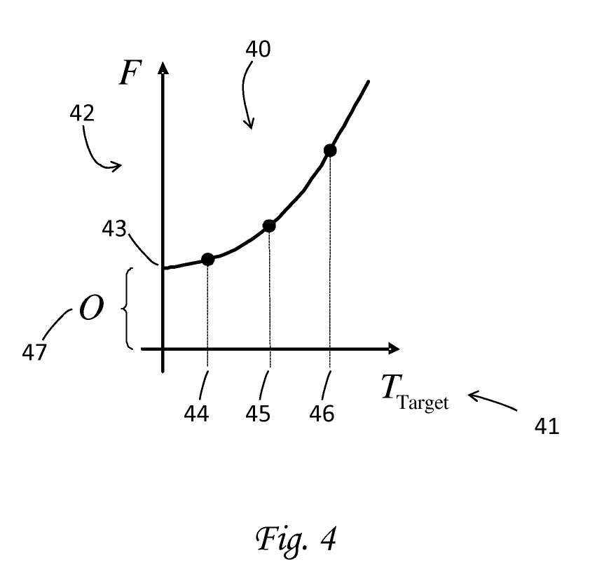

FIG. 4 is a representation of the photon flux F in counts per second as a function of the scene temperature. Each of the three points illustrated in FIG. 4 is the slope of the corresponding curve shown in FIG. 2. The Planckian emission is not a linear function of temperature, thus yielding non-linear, convex curves as the one displayed in FIG. 4. The dark flux O is the value of the flux at zero scene temperature. This dark flux is analogous to a “dark current”, and is due to signal originating from the instrument itself since the scene does not emit any radiation at 0 K. This dark flux is generally due to the radiant emission of the optical assembly, as well as the dark current inside the detector and associated electronics.

With an n×m array detector, one considers having n×m independent detectors. In general each pixel has its own C curve, C_{off}, F curve as well as its own t_{off}.

### Overview of Calibration Process

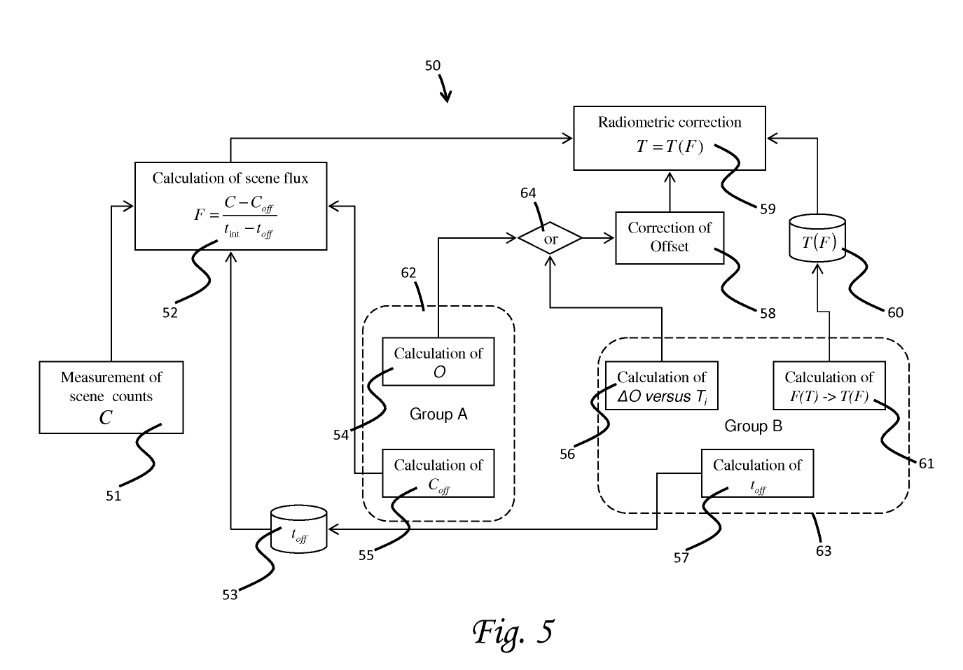

The first step of the radiometric calibration is to acquire a nominal flux curve F(T). A curve similar to that shown in FIG. 4 is acquired using a high-quality black body simulator operated at temperature setpoints chosen to span the range of temperatures for scenes of interest. During each of these measurements, the integration time is changed to at least two values in order to be able to calculate the flux values, which are given by ΔC/Δtᵢₙₜ. The obtained flux data points are F versus T. This relationship is inversed in item 61 of FIG. 5 to obtain T(F) as indicated.

The nominal flux curve is normally acquired in a laboratory using a black body simulator external to the infrared detector as illustrated by the “Group B” dashed rounded rectangle in FIG. 5. The frequency of the determination of the nominal flux curve is dependent on the stability of the gain of the instrument. Ideally this relationship is determined only once in factory.

Efforts are to be spent to ensure that the instrument remains stable in temperature during the acquisition of the nominal flux curve, since a change in instrument temperature affects the dark flux O.

During this first step, the integration time origin t_{off} is determined, as discussed previously, by identifying the integration time where the curves cross for different black body simulator temperatures. This is also indicated in item 57 of FIG. 5.

When the calibration coefficients are applied in the field later on, it is likely that the dark flux O of the instrument will have changed because of variations of the instrument temperature. It is assumed however that the shape of the F curve has not changed since the gain of the instrument is assumed to stay constant in time. In other words, it is assumed that the F curve is simply shifting up or down. This correction appears as item 58 in FIG. 5.

The second step of the radiometric calibration is performed in order to determine this adjustment of the flux curve. In order to determine the change of dark flux O the calibration source (item 12 in FIG. 1) is used in the following manner. Measurements are performed with the calibration source at two different integration times to calculate the corresponding C_{off} and flux F. This is represented as item 54 “Calculation of O” in FIG. 5.

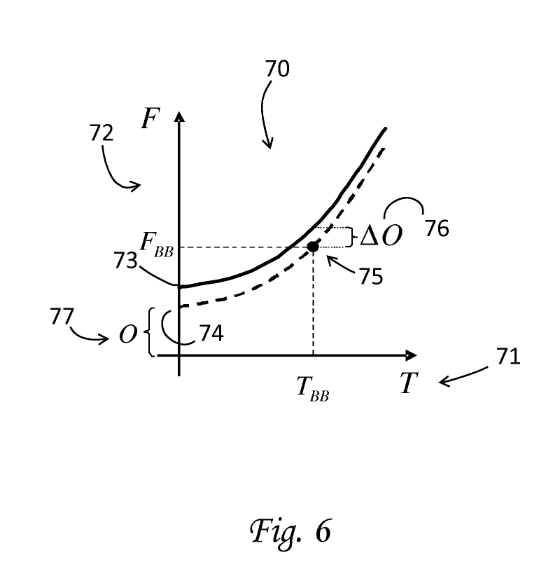

Since the temperature of the black body simulator is also measured, a (T, F) datum can be placed on the F graph as illustrated in FIG. 6. The vertical shift between the laboratory-acquired nominal flux curve and the new datum is the change in dark flux ΔO. The nominal flux curve can be shifted by the dark flux variation ΔO to obtain the corrected flux curve.

Since any calibration source temperature is acceptable to perform this step, the temperature of the calibration source (item 12 in FIG. 1) does not need to be controlled. Only an accurate temperature measurement of the calibration source is used.

If the dark flux O is mostly determined by the temperature of the instrument, the determination of the change of dark flux O is best performed in the field, as illustrated by the “Group A” dashed rounded rectangle in FIG. 5.

Alternatively this change of dark flux ΔO can be characterized in the laboratory by recording the signal at the sensor versus the temperature of the sensor while observing a high-accuracy black body simulator at constant temperature. A ΔO versus instrument temperature is prepared as a lookup table. This is indicated in item 56 “Calculation of ΔO versus Tᵢ” in FIG. 5.

When using this alternate approach in the field, the temperature of the sensor is simply measured so ΔO is obtained from the lookup table.

With this approach, the internal black body simulator can still be used to calculate the C_{off}, which is used to calibrate the scene measurements. This is indicated as item 55 “Calculation of C_{off}” in FIG. 5.

Alternatively, a target other than a black body simulator can be used to determine the C_{off}. Any object with a stable radiance during the short period of time during which the counts at at least two integration times are acquired, is acceptable. The C_{off} is extracted from calculating the ordinate value at t_{off} for the curve defined by these data points.

A third step may be needed to perform a complete radiometric calibration. This is because, in most applications, the calibration source (item 12 in FIG. 1) is not located in front of the foreoptics (item 11 in FIG. 1) but rather after this lens for reasons of compactness and ruggedness. One should compensate for the variation in the offset and gain caused by the foreoptics that is not taken into account by the calibration measurements. For this purpose the signal at the sensor without the foreoptics versus the temperature of the sensor is acquired while observing a high-accuracy black body simulator at constant temperature. This measurement is very similar to the measurement described previously, but without the foreoptics. By comparing the two datasets, it is possible to assess the impact of the foreoptics on the radiometric gain and the offset at all foreoptics temperature. These effects can later be compensated in the field based on lookup tables, part of item 56 of FIG. 5.

Using all these calibration coefficients, the scene count measurements (“C” item 51 in FIG. 5) is first converted to flux using the item 52 “calculation of scene flux” relation in FIG. 5. First the C_{off} from the scene counts is subtracted and divided by the integration time used for the measurements with t_{off} removed.

In most instances, the goal of the user of the infrared detector instrument is to measure the radiometric temperature of a scene. Next a flux-to-temperature conversion is performed by interpolating in the stored F vs T curve as in the item 59 “Radiometric correction” in FIG. 5, with inclusion of the proper change in dark flux ΔO (item 58 of FIG. 5).

For each different foreoptics module, a proper set of calibration coefficients can be determined using the same approach. The calibrated data with a given foreoptics module is obtained using the appropriate set of calibration coefficients.

For each different gain selection of the infrared detectors, a proper set of calibration coefficients can be determined using the same approach. The calibrated data with a particular gain of the infrared detectors is obtained using the appropriate set of calibration coefficients.

### Detailed Calibration Procedure

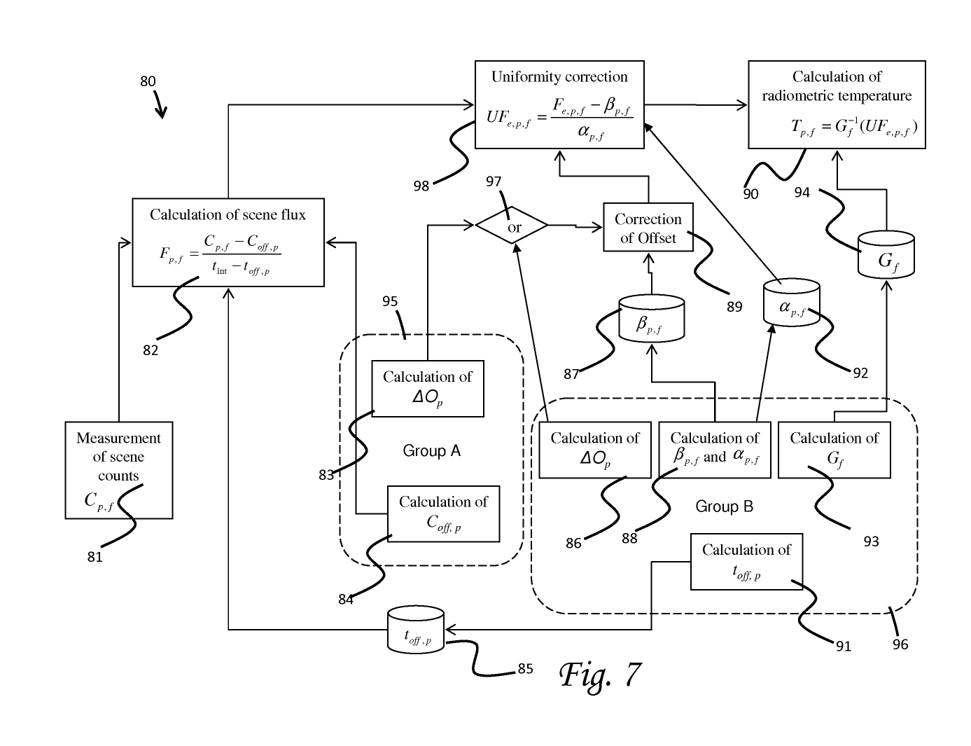

FIG. 7 presents the radiometric calibration steps in more details. Realistic steps are described for computational efficiency. In a similar fashion as for FIG. 5, the top equations, uniformity correction 98 and calculation of radiometric temperature 90 are the final equations used to transform the measurement C_{p, f} (item 81 of FIG. 7) into a calibrated result in temperature units. Alternatively, the quantity “tᵢₙₜ×UF” may be used as an output to provide a uniform uncalibrated image.

Table 1 and Table 2 describe the variables and subscripts used herein.

TABLE 1
Definitions of variables

| Symbol | Description | Units |
|---|---|---|
| C | Detector raw counts | counts |
| F | Detected flux | counts/second |
| Fₑ | Flux of the extended instrument (with | counts/second |
| | fore optics) | |
| Fᵢ | Flux of the internal instrument (without | counts/second |
| | fore optics) | |
| UF | Uniform detected flux | counts/second |
| Tₛ | Temperature of the scene. It is suggested that | Celsius |
| | the number of scene temperatures could be 5 | |
| | to collect the lookup table. | |
| T_{amb} | Temperature of the environmental chamber | Celsius |
| Tᵢ | Internal temperature of instrument | Celsius |
| T_{fore} | Temperature of the fore optics | Celsius |

TABLE 2
Definitions of subscripts

| Subscripts | Description | Note |
|---|---|---|
| p | Stands for pixel number | |
| f | Stands for filter or filter | For example 8 spectral filters |
| | combination. | and 3 neutral density filters |
| | | yield a total of 24 possibilities. |
| e | Refers to the extended | When relations are both |
| | instrument, inclusive of the | applicable to extended and |
| | foreoptics | internal instrument, the ^{e} and ⁱ |
| i | Refers to the internal | subscripts are dropped for |
| | instrument, exclusive of the | readability |
| | foreoptics | |
| e | | G_{f}, α_{p, f} and β_{p, f} are always |
| | | related to the extended |
| | | instrument, so the e subscript is |
| | | dropped |
| n | The parameter n in | Without noise, all numbers |
| | C_{p, f, T}_{ₛ}_{, t}_{ᵢₙₜ} (n) indicates the | C_{p, f, T}_{ₛ}_{, t}_{ᵢₙₜ} (n) would be |
| | acquisition sample number, | the same |
| | where everything is fixed, | |
| | including the integration | |
| | tᵢₙₜ. | |

### Laboratory Measurements and Calculations

There are three experiments that are suggested to be performed in laboratory prior to detector use. The goal of the three experiments is to able to 1) to compensate for the change in internal offset, 2) to compensate for the change in foreoptics offset and 3) to convert the scene flux into temperature units using a look-up table. Alternatively, these experiments can be performed in the field if the appropriate blackbodies are available as portable equipment or integrated in the instrument. As will be readily understood, if the foreoptics are absent from the detector, the second experiment is superfluous and can be omitted.

The first experiment consists in placing the instrument without the foreoptics lens in an environmental chamber operated at T_{amb} in such a way that all of the instrument pixels can view a black body simulator. The black body is set at a fixed temperature while T_{amb} is varied over the range of operation of the detector. The obtained set of measurements consists in Fᵢ vs Tᵢ.

The second experiment consists in placing the instrument with its foreoptics lens in an environmental chamber operated at T_{amb} in such a way that all of the instrument pixels can view a black body simulator. The black body is set at a fixed temperature while T_{amb} is varied over the range of operation of the detector. The obtained set of measurements consists in Fₑ vs T_{fore}.

The third experiment consists in placing the instrument with its foreoptics lens, if any, in an environmental chamber operated at a constant T_{amb} in such a way that all of the instrument pixels can view a black body simulator. The black body temperature is varied to span the range of expected scene temperatures. The obtained set of measurements consists in Fₑ vs Tₛ. For most extended range of temperature, there will be a need for multiple black body setups.

### Flux Curve and Global Response G_{f}

The global response G_{f} illustrated as item 94 of FIG. 7 is a derivative of the flux curves F(T) and is introduced to lower the detector embedded memory requirement. As mentioned previously, the flux curves are non-linear functions and can be implemented efficiently in the detector real time processing using a lookup table. A lookup table is a very computationally efficient method but typically uses a relatively large amount of memory. A solution is to find a unique global response G_{f} that is representative of the flux curve for all pixels so that the pixels can be represented by a single G_{f} function in addition to two correction parameters per pixel (α_{p, f} and β_{p, f}) as expressed in Equation 8. If all the pixels of the focal plane were identical, then α_{p, f}=1, β_{p, f}=0.

F_{e, p, f}(T)=α_{p, f}·G_{f}(T)+β_{p, f} Equation 8

The global response G_{f} is found using Equation 9. To avoid problems that would occur with anomalous pixels, the median is used rather than the average since it automatically rejects saturated and untypical pixels. The anomalous pixels are often referred to as “bad pixels” and can include pixels considered anomalous because of their response which is very different from that of their neighboring pixels (some of their basic characteristics are too far from the average values, for example if the gain coefficients associated with the pixel is too low compared with the average) and can also include pixels which do not react as expected during the calibration process. Typical good MWIR FPA have less than 1% bad pixels. “Good pixels” are those not declared “bad pixels”. Often, a Bad Pixel Replacement (BPR) step is included in the processing unit of the infrared detector to replace the bad pixels by a value provided by the neighboring pixels. Equation 9 discards bad pixels while allowing to find the global response G_{f}.

$${G}_{f} ( T ) = {median}_{pixel} {F}_{e , p , f} ( T ) \qquad Equation 9$$

For each pixel and each filter, a linear fit of α_{p, f}·G _{f}(T)+β_{p, f} against G_{f}(T) is used to find α_{p, f} and β_{p, f}. The resulting gain α_{p, f} and offset β_{p, f} parameters are stored as items 92 and 87 of FIG. 7 and used subsequently in the application (item 98 of FIG. 7) of the calibration coefficients. Pixels that yield a large difference between the fitted and experimental F_{e, p, f}(T) can be tagged as defective.

### Interpolation/Extrapolation

The global response is measured at a small number of temperature points, of the order of five temperature points. On the other hand, the inverse G_{f}(T) relationship (item 90 of FIG. 7) is used continuously in the final step of the radiometric correction according to the calculated scene flux. In order to enable a meaningful and robust interpolation/extrapolation, a physically based model is now described.

First, the radiometric model is described in Equation 10.

$$F ( T ) = \frac{C ( T ) - {C}_{off}}{{t}_{int} - {t}_{off}} = {\int }_{0}^{∞} R ( σ ) [ L ( σ , T ) + O ( σ , {T}_{i} , {T}_{fore} ) ] d σ \qquad Equation 10$$

where R(σ) is the response of the extended instrument, L(σ, T) is the photonic spectral radiance in photons/(s sr m² m⁻¹), Tᵢ is the instrument internal temperature and T_{fore} is the fore optics temperature.

In addition to their limited temperature range, real-life black bodies feature non-unitary emissivity, so for the best accuracy, the reflection of the surrounding radiance can also be taken into account as described in Equation 2. The source of radiance is a black body BB of known emissivity ε_{BB}(σ). Its radiance is given by Equation 11.

L(σ, T_{BB})=ε_{BB}(σ)P(σ, T_{BB})+(1−ε_{BB}(σ))P(σ, T_{amb}) Equation 11

Where P(σ, T) is Planck's black body photonic radiance, T_{BB} is the black body temperature and T_{amb} is the ambient temperature surrounding the black body.

Equation 10 and Equation 11 can be combined and written as Equation 12.

$$F ( T ) = {\int }_{0}^{∞} R ( σ ) {ɛ}_{BB} ( σ ) P ( σ , T ) d σ + {O}_{total} ( {T}_{amb} , {T}_{i} , {T}_{fore} ) \qquad Equation 12$$

Where Oₜₒₜₐₗ(T_{amb}, Tᵢ, T_{fore}) is given by Equation 13.

$${O}_{total} ( {T}_{amb} , {T}_{i} , {T}_{fore} ) = {\int }_{0}^{∞} R ( σ ) ( 1 - {ɛ}_{BB} ( σ ) ) P ( σ , {T}_{amb} ) d σ + {\int }_{0}^{∞} R ( σ ) O ( σ , {T}_{i} , {T}_{fore} ) d σ \qquad Equation 13$$

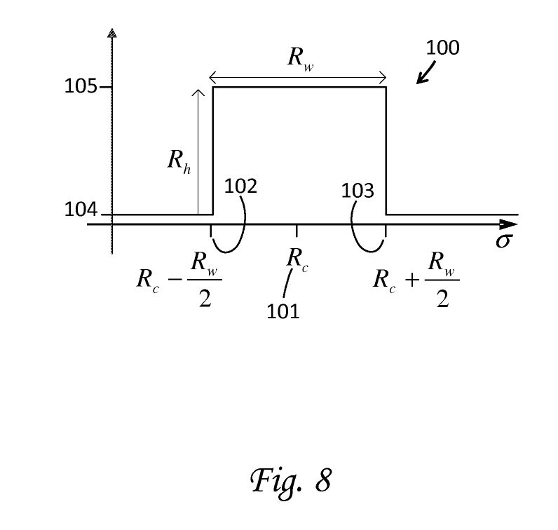

It is assumed that the instrument equivalent response R(σ) is a “top hat” function defined by 3 parameters, namely the width R_{w}, the height Rₕ and the wavenumber center R_{c} as illustrated in FIG. 8.

Using the “top hat” instrument equivalent response R(σ), Equation 12 can be rewritten as Equation 14.

$$F ( T ) = {R}_{h} {\int }_{{R}_{c} - \frac{{R}_{w}}{2}}^{{R}_{c} + \frac{{R}_{w}}{2}} {ɛ}_{BB} ( σ ) P ( σ , T ) d σ + {O}_{total} ( {T}_{amb} , {T}_{i} , {T}_{fore} ) \qquad Equation 14$$

In order to exploit the physical model, the four parameters R_{w}, Rₕ, R_{c} and Oₜₒₜₐₗ(T_{amb}, Tᵢ, T_{fore}) are evaluated by “fitting” the experimental measurements acquired in the third experiment.

One convenient method to identify these parameters is to calculate the difference of measurements at two different temperatures, and the ratio of differences, as described below.

First the experimental ratio of differences of fluxes mrᵢⱼₖₗ is defined at four different temperatures Tᵢ, Tⱼ, Tₖ, and Tₗ given by Equation 15.

$${mr}_{ijkl} = \frac{F ( {T}_{i} ) - F ( {T}_{j} )}{F ( {T}_{k} ) - F ( {T}_{l} )} \qquad Equation 15$$

Using Equation 14, the theoretical ratio of difference of flux trᵢⱼₖₗ at four different temperatures Tᵢ, Tⱼ, Tₖ, and Tₗ is given by Equation 16. The advantage of the ratio of differences of fluxes is the elimination of the offset and the Rₕ.

$${tr}_{ijkl} ( {R}_{c} , {R}_{w} ) = \frac{{td}_{ij}}{{td}_{kl}} = \frac{\begin{matrix}{\int }_{{R}_{c} - \frac{{R}_{w}}{2}}^{{R}_{c} + \frac{{R}_{w}}{2}} {ɛ}_{BB} ( σ ) P ( σ , {T}_{i} ) d σ - \\ {\int }_{{R}_{c} - \frac{{R}_{w}}{2}}^{{R}_{c} + \frac{{R}_{w}}{2}} {ɛ}_{BB} ( σ ) P ( σ , {T}_{j} ) d σ\end{matrix}}{\begin{matrix}{\int }_{{R}_{c} - \frac{{R}_{w}}{2}}^{{R}_{c} + \frac{{R}_{w}}{2}} {ɛ}_{BB} ( σ ) P ( σ , {T}_{k} ) d σ - \\ {\int }_{{R}_{c} - \frac{{R}_{w}}{2}}^{{R}_{c} + \frac{{R}_{w}}{2}} {ɛ}_{BB} ( σ ) P ( σ , {T}_{l} ) d σ\end{matrix}} \qquad Equation 16$$

R_{c} and R_{w} can be found by fitting these two parameters using the least square sum criterion displayed in Equation 17. Note that the spectral dependency of ε_{BB} is used for the evaluation of Equation 16.

$$( {R}_{c} , {R}_{w} ) = arg {min}_{( {R}_{c} , {R}_{w} )} {\sum }_{i , j , k , l} {( {mr}_{ijkl} - {tr}_{ijkl} )}^{2} \qquad Equation 17$$

Next, the experimental difference of flux mdᵢⱼ is obtained at two different temperatures Tᵢ and Tⱼ, given by Equation 18.

mdᵢⱼ=F(Tᵢ)−F(Tⱼ) Equation 18

The theoretical difference of flux tdᵢⱼ at two different temperatures Tᵢ and Tⱼ is given by Equation 19. The advantage of the difference of flux is the elimination of the offset term.

$${td}_{ij} ( {R}_{c} , {R}_{w} ) = {R}_{h} \{ \begin{matrix}{\int }_{{R}_{c} - \frac{{R}_{w}}{2}}^{{R}_{c} + \frac{{R}_{w}}{2}} {ɛ}_{BB} ( σ ) P ( σ , {T}_{i} ) d σ - \\ {\int }_{{R}_{c} - \frac{{R}_{w}}{2}}^{{R}_{c} + \frac{{R}_{w}}{2}} {ɛ}_{BB} ( σ ) P ( σ , {T}_{j} ) d σ\end{matrix} \} \qquad Equation 19$$

Having determined R_{c} and R_{w}, the Rₕ can be now found by fitting this parameter using the least square sum criterion displayed in Equation 20. Note that the spectral dependency of ε_{BB} is used for the evaluation of Equation 19.

$${R}_{h} = arg {min}_{{R}_{h}} {\sum }_{i , j} {( {md}_{ij} - {td}_{ij} )}^{2} \qquad Equation 20$$

Finally, the offset Oₜₒₜₐₗ(T_{amb}, Tᵢ, T_{fore}) in Equation 14 can be found by fitting this parameter using a least square sum criterion displayed in Equation 21.

$${O}_{total} ( {T}_{amb} , {T}_{i} , {T}_{fore} ) = arg {min}_{{O}_{total} ( {T}_{amb} , {T}_{i} , {T}_{fore} )} {\sum }_{s} {[ F ( {T}_{s} ) - {R}_{h} {\int }_{{R}_{c} - \frac{{R}_{w}}{2}}^{{R}_{c} + \frac{{R}_{w}}{2}} {ɛ}_{BB} ( σ ) P ( σ , {T}_{s} ) d σ ]}^{2} \qquad Equation 21$$

With the four parameters R_{c}, R_{w}, Rₕ and Oₜₒₜₐₗ(T_{amb},Tᵢ, T_{fore}), one can generate as many F(T) points as desired using Equation 14 and Equation 13. However the temperatures obtained from the inverse relation T(F) are specific to the black body used for the experimental measurements. Ideally the temperature obtained from the lookup table would refer to a “perfect” black body with an emissivity of 1.

The generation of corrected flux points F′(T) corresponding to an ideal black body can be performed by using Equation 22. The ambient temperature is assumed to be known from a laboratory measurement.

$${F}^{′} ( T ) = {R}_{h} {\int }_{{R}_{c} - \frac{{R}_{w}}{2}}^{{R}_{c} + \frac{{R}_{w}}{2}} P ( σ , T ) d σ + {O}_{total} ( {T}_{amb} , {T}_{i} , {T}_{fore} ) d σ - {R}_{h} {\int }_{{R}_{c} - \frac{{R}_{w}}{2}}^{{R}_{c} + \frac{{R}_{w}}{2}} R ( σ ) ( 1 - {ɛ}_{BB} ( σ ) ) P ( σ , {T}_{amb} ) \qquad Equation 22$$

### Multiple Black Body Approach.

Standard large area black body simulators cannot typically be operated accurately at elevated temperatures. An approximate upper limit for a 10 cm×10 cm black body is 100-200° C. A multiple black body approach is described in order to calibrate IR detectors over a temperature range beyond this limit. Higher temperature black body simulators are available in smaller format, usually smaller than the field of view of detectors. In this case some collimating optics can be used to ensure that the detector field of view is filled. This collimating optics degrades the accuracy of the etalon by adding a gain factor (imperfect transmission or reflection of the collimating optics) and an offset term (emission of the collimating optics). However these effects can be minimized by selecting a collimating optics with low emission and by determining the gain and offset parameters by transfer from a high accuracy, low temperature black body in the intermediate temperature range, where both black bodies can be operated. Measurements at two different temperatures are sufficient to determine both gain and offset parameters.

The integration time origin t_{off} is determined during measurement of the flux curves, as discussed previously, by identifying the integration time where the curves cross for different black body simulator temperatures. This is also indicated in item 91 of FIG. 7.

Correction of the flux offset is done to compensate for variations of the instrument temperature and corresponding instrument self emission. In the presented formalism, this is done by correcting the offset β_{p, f} parameters as illustrated in item 89 of FIG. 7. Two methods are described, either item 83 or item 86 of FIG. 7. The best method depends on what limitation is dominant; either the instrument drift or the calibration source errors.

The “Group A” method can be performed at all times in the field using the internal calibration source (item 12 in FIG. 1). This method can be performed very rapidly, but its accuracy depends on the emissivity of the internal calibration source.

An alternate “Group B” method is performed in the laboratory using the first and second experiments. In this case the variations of the instrument internal signal and foreoptics signal are recorded as a function of their sensed temperatures. The correction applied in the field is based on the sensed temperatures. Both of these effects are represented by item 86 in FIG. 7.

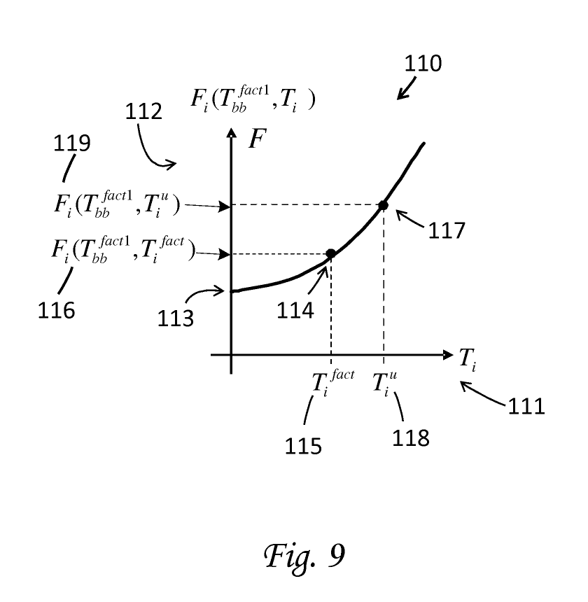

The evaluation of instrument internal offset is performed using the data acquired in the first laboratory experiment. FIG. 9 shows a curve collected during this experiment. The flux is measured for an arbitrary but constant black body temperature T_{bb}^{fact1}. Equation 23 describes how to use the acquired data. When in the field, the offset variation ΔO(Tᵢ^{u}, Tᵢ^{fact3}) is estimated by subtracting the Fᵢ value evaluated at the third experiment temperature from the Fᵢ value evaluated at the field temperature. The function is referenced to the third experiment, since the data from the third experiment is used to derive the G_{f} function from which the gain α_{p, f} and offset β_{p, f} parameters are derived.

ΔOᵢ(tᵢ^{u}, Tᵢ^{fact3})=Fᵢ(T_{bb}^{fact1}, Tᵢ^{u})−Fᵢ(T_{bb}^{fact1}, Tᵢ^{fact3}) Equation 23

Where T_{bb}^{fact1} is the fixed black body temperature during experiment 1, Tᵢ^{u} is the internal instrument temperature in the field and Tᵢ^{fact3} is the internal instrument temperature during experiment 3.

The evaluation of fore optics offset is somewhat more complicated since it involves the use of the first and second experiment. During the second experiment a Fₑ curve versus T_{fore} is acquired, in a similar fashion as that shown in FIG. 9. One additional relation is T_{fore}Tᵢ, the relationship between T_{fore} the foreoptics temperature and Tᵢ the instrument temperature collected during the second experiment. The scheme for the calculation of the correction of foreoptics offset ΔO_{fore}(T_{fore}^{u}, T_{fore}^{fact3}) is described in Equation 24.

ΔO_{fore}(T_{fore}^{u}, T_{fore}^{fact3})=Fₑ(T_{bb}^{fact2}, TforeTi(T_{fore}^{u}), T_{fore}^{u})−Fₑ(T_{bb}^{fact2}, TforeTi(T_{fore}^{fact3}), T_{fore}^{fact3})−[Fᵢ(T_{bb}^{fact1}, TforeTi(T_{fore}^{u}))−Fᵢ(T_{bb}^{fact1}, TforeTi(T_{fore}^{fact3}))] Equation 24

### Calibration Process Summary

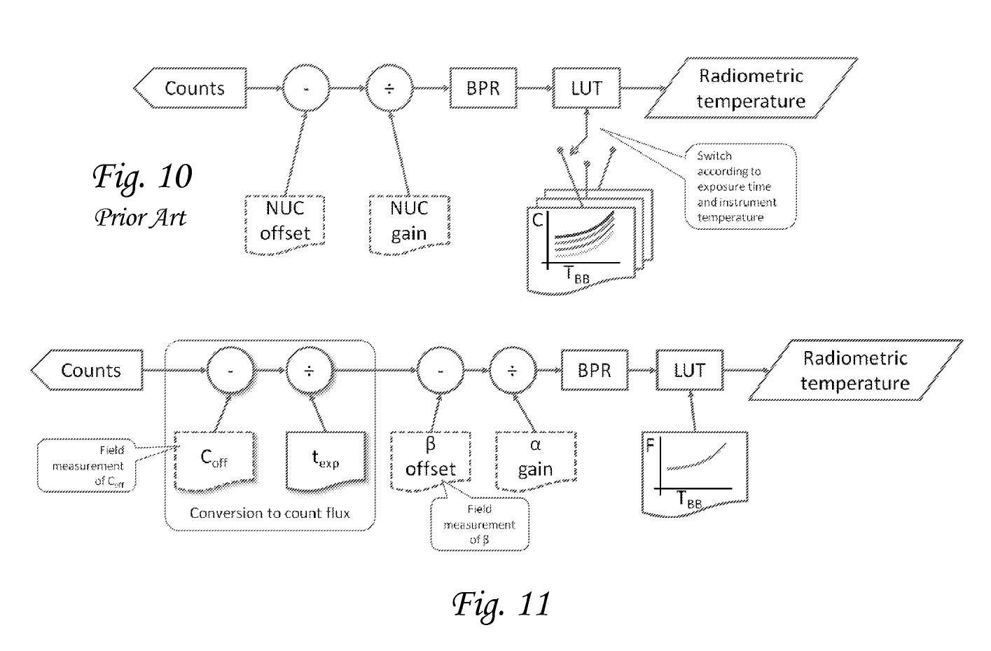

This present calibration method therefore allows implicitly taking into account the integration time and thus reducing the number of calibration data that are acquired and stored. In FIG. 10 and FIG. 11, dashed boxes represent pixel-wise parameters. NUC stands for non-uniformity correction, BPR stands for bad pixel replacement and LUT stands for look-up table.

With the prior art methods, scene data are calibrated in a two-step process. First a non-uniformity correction (NUC) is applied using pixel-wise gain and offset coefficients, as shown in FIG. 10. These coefficients are obtained without worrying about the absolute and physically significant values. Once the NUC is applied, all pixels are considered to be equivalent, and a radiometric characterization is performed experimentally using recorded NUC counts versus target temperature relationships, as shown in FIG. 10. Since the pixels are considered to be equivalent, spatially averaged values are used to acquire these curves. The radiometric characterization is performed using high-accuracy blackbodies over the range of temperature of interest for the scene, for all exposures times of interest and if possible for all camera temperatures of interest.

The method described herein performs the radiometric calibration using count fluxes rather than counts. When applying this method, the first step consists in converting counts into fluxes by subtracting the C_{off} and dividing by the exposure time tₑₓₚ as shown in FIG. 11. After conversion to fluxes, the pixel-wise offset and gain coefficients are applied in order to render all pixels equivalent, allowing a single flux versus temperature relationship to be applied to all pixels and for all integration times. This step removes the need to have several flux-to-temperature relationships as illustrated by the look-up table (LUT) relationships in FIG. 10.

### Experimental Results Example

### Description of Example Camera

The calibration method described herein has been validated using the FAST-IR MW, a high-speed MWIR camera manufactured by Telops Inc. The camera is designed for high-speed operation (1000 full frames per second) and features the embedded electronics necessary to perform the radiometric calibration described herein in real-time on the full data rate (>100 000 000 pixels/s). The camera has enough memory to store up to 5 coefficients per pixel times 8 to support a eight-position filter wheel as well as additional vectors such as the F(T) lookup table. The Telops FAST-IR MW camera abridged specifications are as follows in Table 3.

TABLE 3
Telops FAST-IR MW camera abridged specifications

| Specification | Value |
|---|---|
| Frame size | 320 × 256 |
| Spectral range | 3 μm to 5 μm |
| Maximum full frame | 1000 Hz |
| rate | |
| NeDT(1σ) | 14 mK |
| Radiometric | 1 K or 1% (° C.) |
| temperature | |
| accuracy (1σ) | |

### Preliminary Example Results

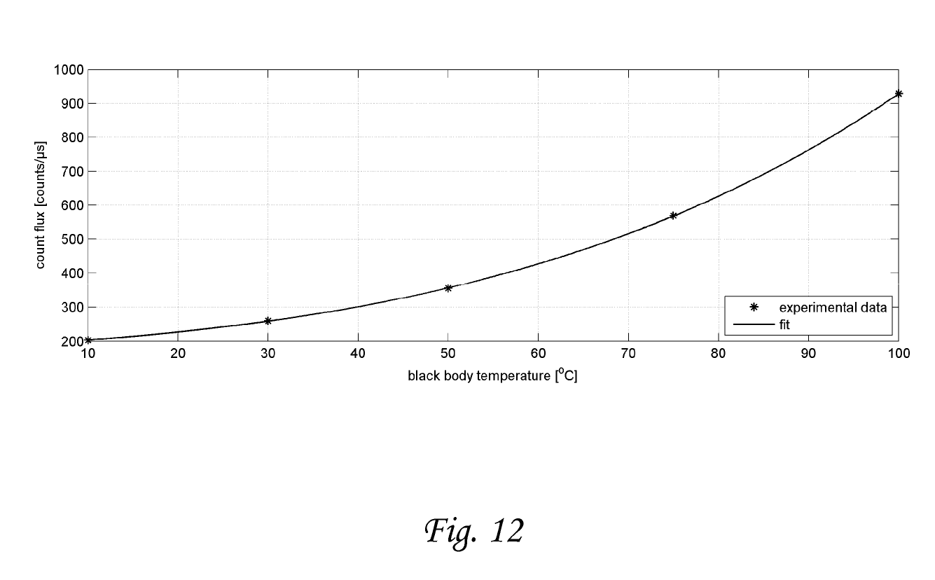

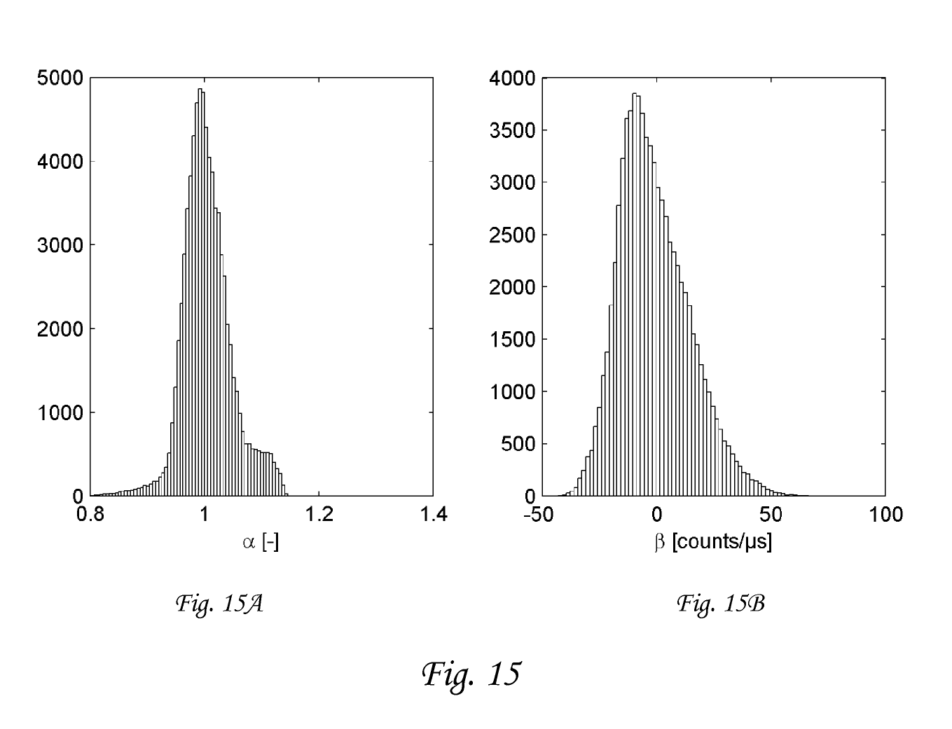

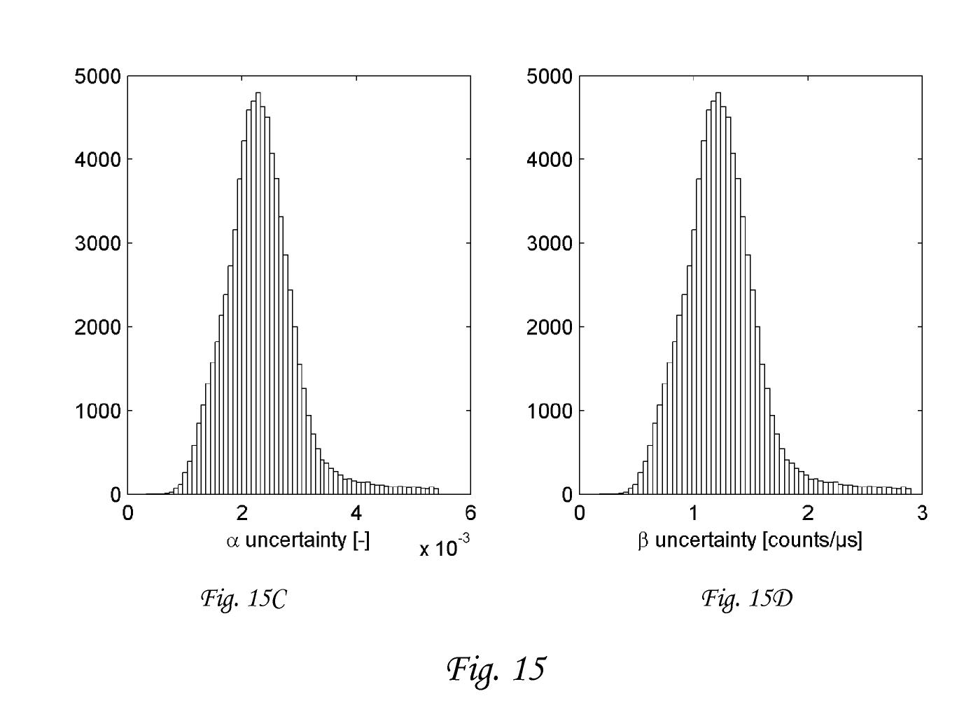

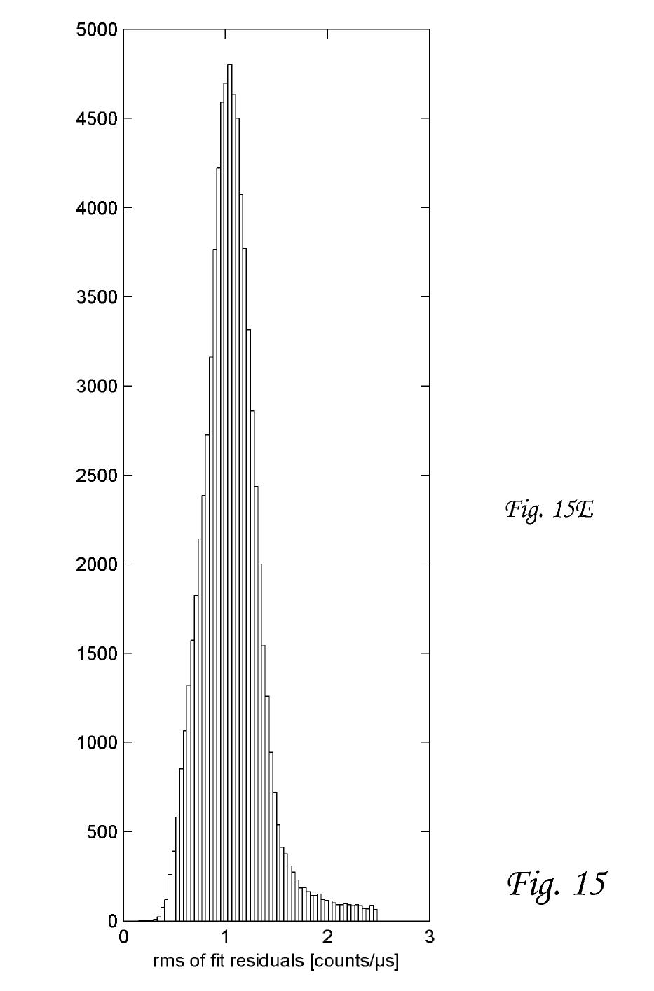

Calibration and scene data was acquired with the FAST-IR MW viewing a 4-inch×4-inch CI SR-800-4A blackbody with a 100 mm lens. Measurements were performed at 10° C., 30° C., 50° C., 75° C. and 100° C., as shown in FIG. 12, each at six exposure times selected to result in integration charges that fill approximately 15%, 25%, 40%, 50%, 60% and 70% of the maximum count. The nominal flux curve F(T) and the gain α and offset β coefficients obtained are shown in FIG. 12 and Erreur! Source du renvoi introuvable. FIG. 15, respectively.

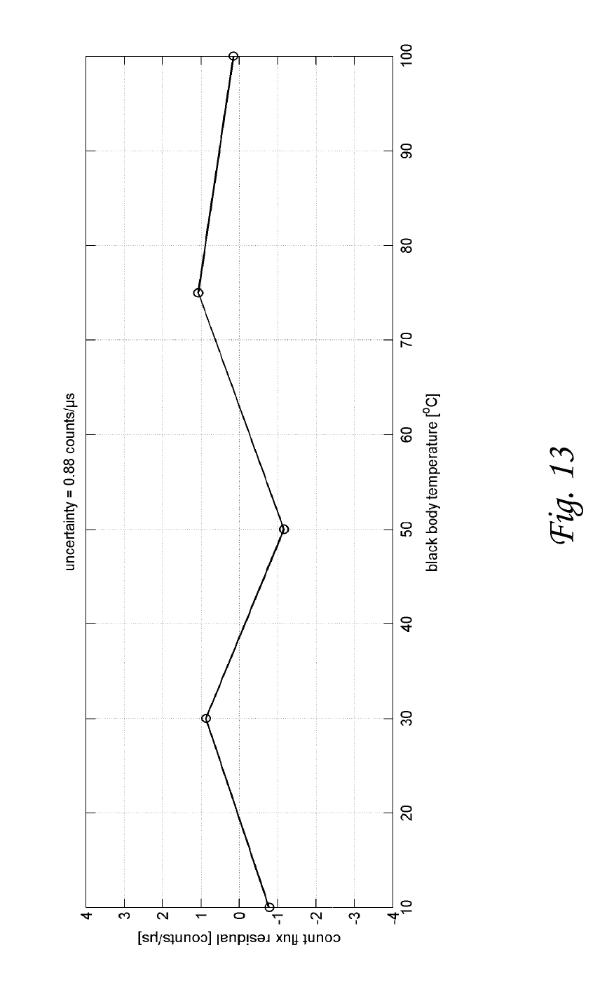

The obtained flux data points are series of F^{p}ᵢ versus Tᵢ pairs, one series for each pixel, as indicated by the superscript “p”. The individual F^{p}ᵢ versus Tᵢ series are processed in order to obtain one “average” Fᵢ versus Tᵢ series, as illustrated as blue stars in FIG. 12. This series is then fitted using an appropriate mathematical expression (curve in FIG. 12). FIG. 12 shows the determination of the nominal flux curve F(T) for a 3 μm-5 μm infrared camera for blackbody temperatures from 10° C. to 100° C. The experimental data is statistically representative of all good pixels data. The curve is a standard mathematical function used to fit the data and achieved a good fit with an uncertainty of 0.88 counts/μs over the range 200 counts/μs to 900 counts/μs as shown in FIG. 13.

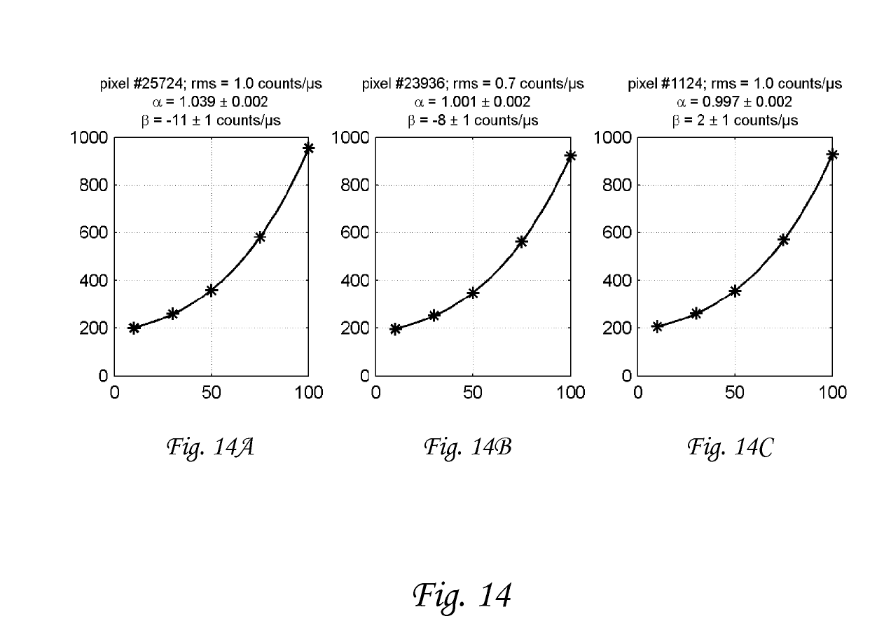

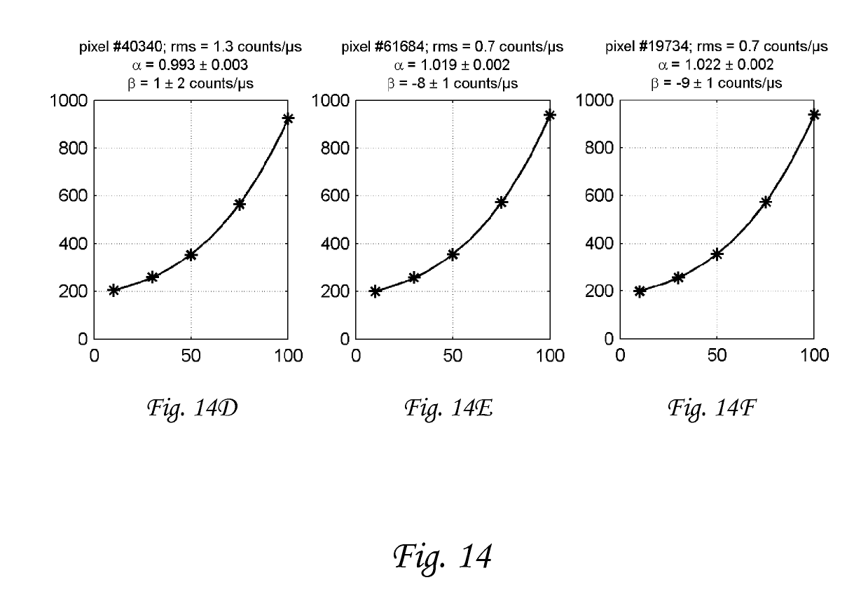

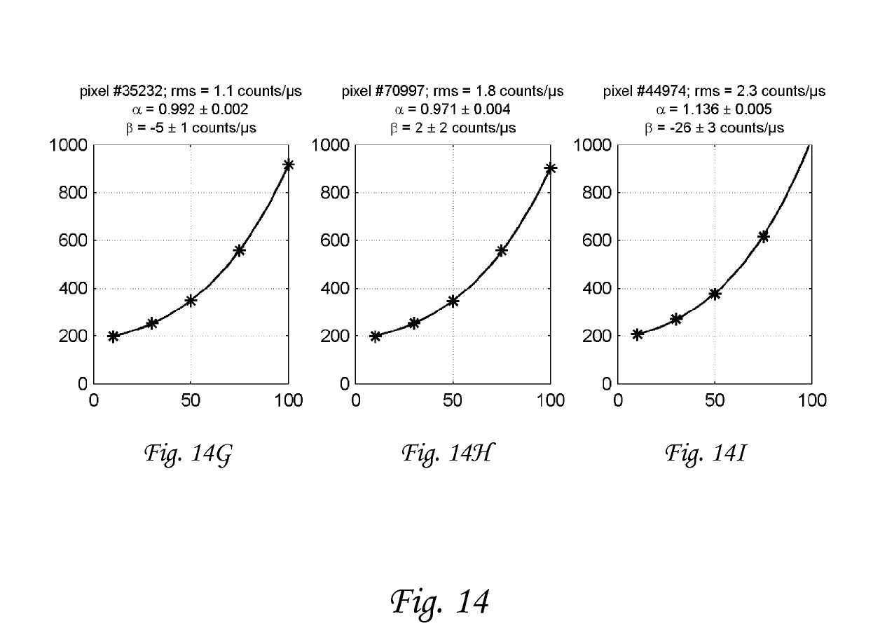

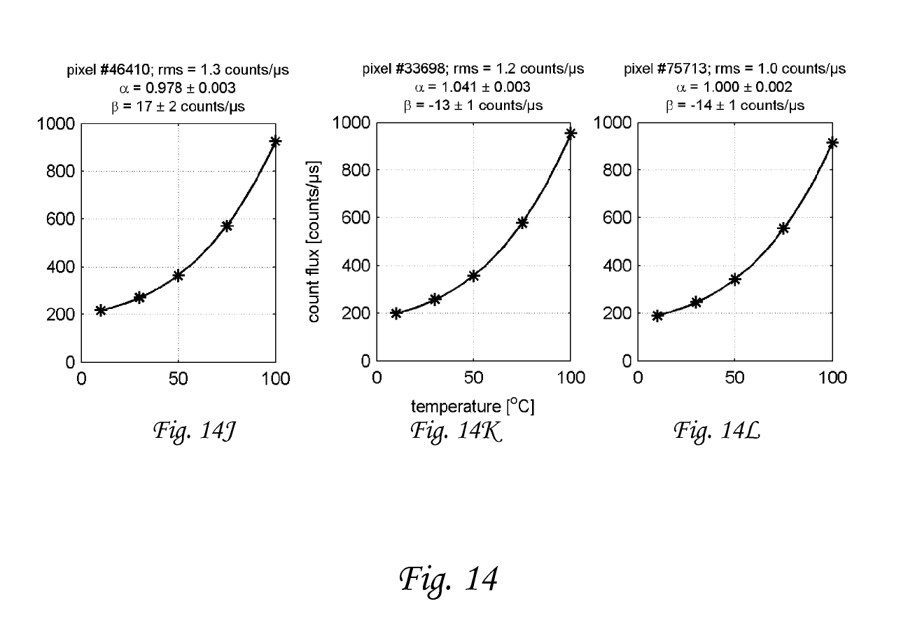

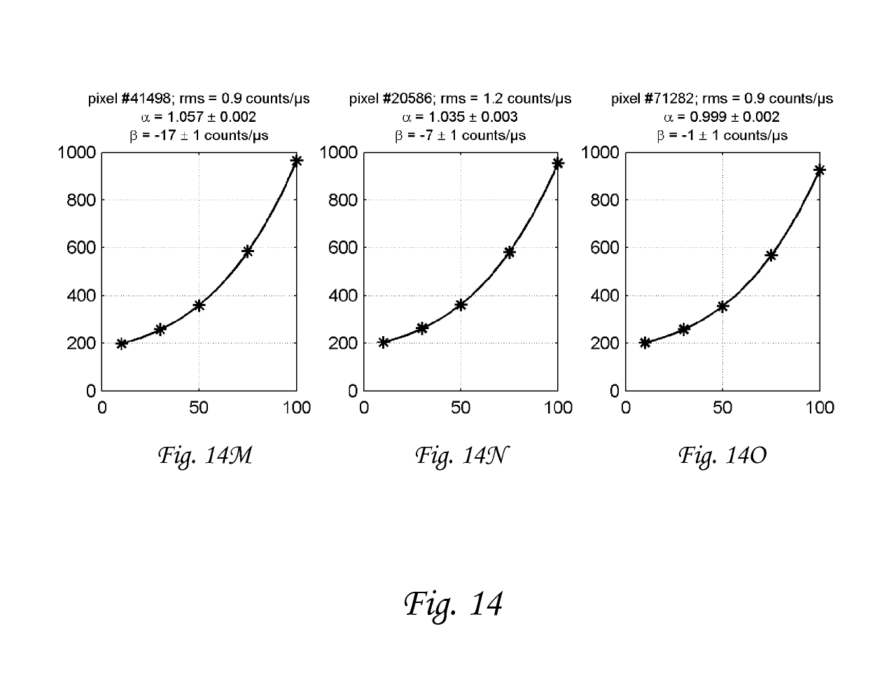

Examples of single-pixel fits obtained for 15 randomly selected good pixels, for a 3 μm-5 μm infrared camera are shown in FIG. 14 which comprises FIG. 14A to FIG. 14O The fits are based on the same F(T) curve, scaled by individual gain and offset coefficients. The rms errors are indicated above each plot.

The results for all good pixels of the same camera is shown in FIG. 15 which includes FIG. 15A to FIG. 15E. Histograms of the fitted α and β coefficients (FIG. 15A and FIG. 15B, respectively) and the corresponding fitting uncertainties (FIG. 15C and FIG. 15D, respectively) are shown. Histogram of the fit residuals for all good pixels is shown in FIG. 15E. As expected the average α is close to 1 and the average β is close to 0. The distribution of the α coefficient is indicative of the detector inherent response non-uniformity, roughly ±10%. In this case the rms error is approximately 1 count/μs, over the range 200 counts/μs to 900 counts/μs, which corresponds to quite a low fractional error of 0.5% to 0.011%. This result can be compared with the radiometric requirement of ˜1% and indicates that the described method is viable so that pixels can be represented by a single (nominal) F(T) flux curve using gain (α) and offset (β) corrective coefficients.

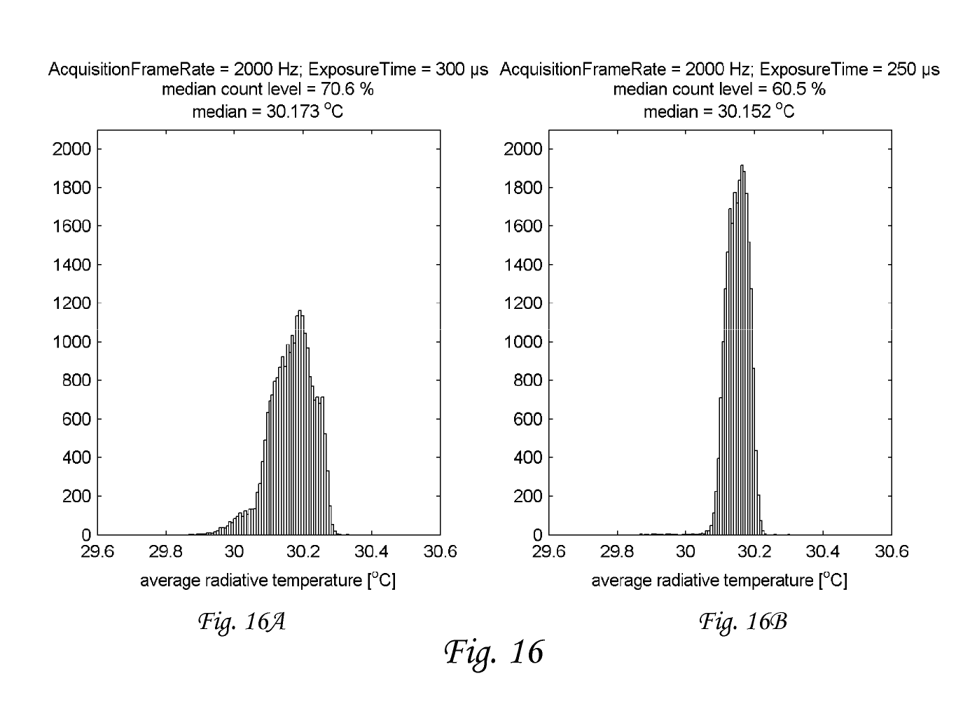

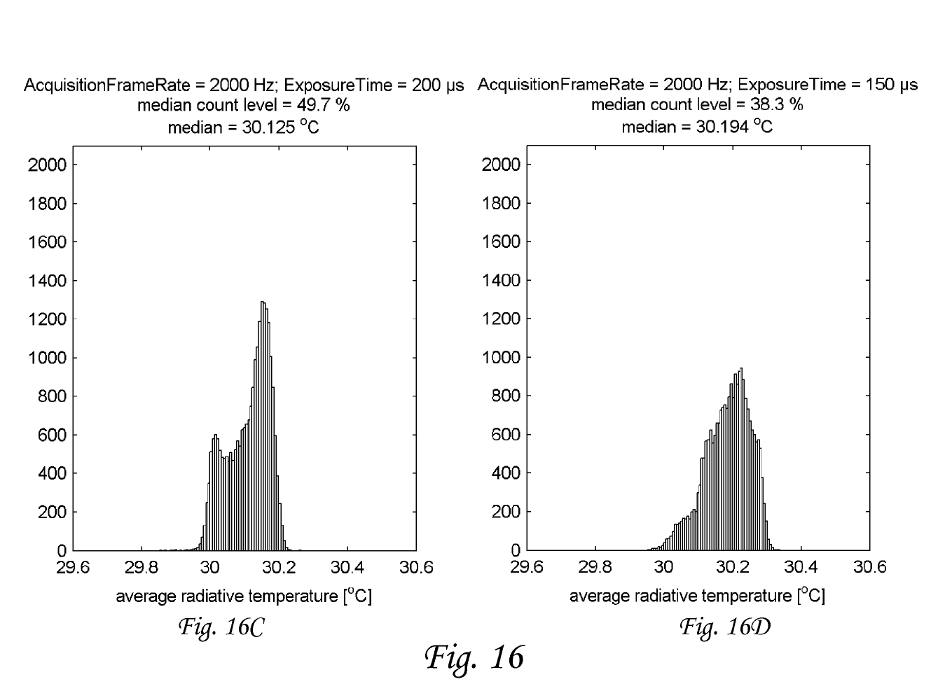

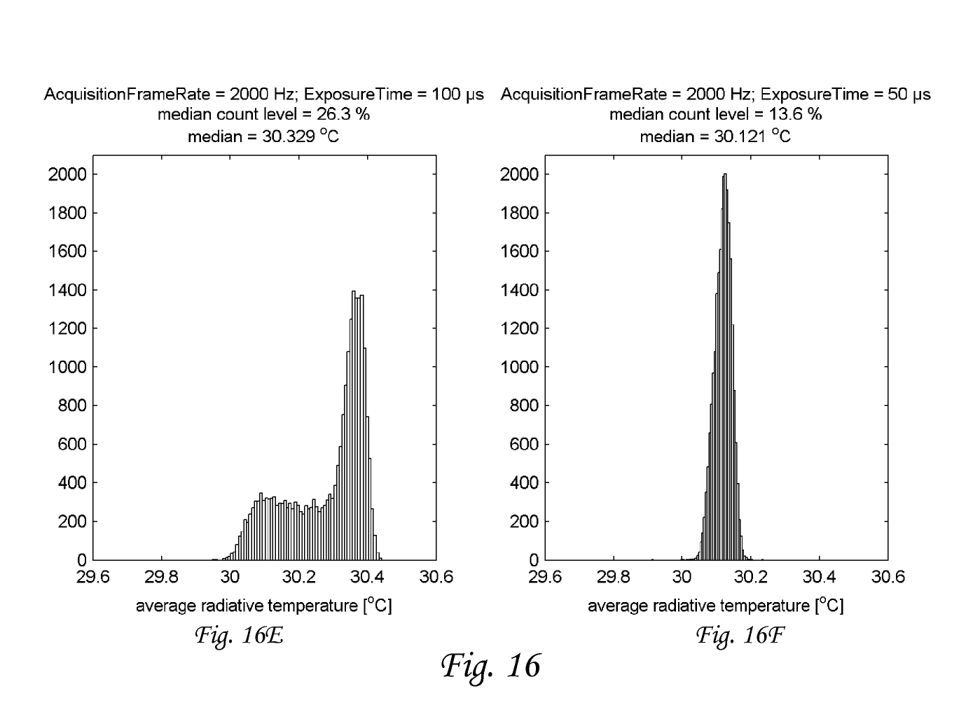

Using these calibrations coefficients and the method described herein, the measurements of the 30° C. blackbody for the six different exposure times were radiometrically corrected. The results are shown in FIG. 16, where histograms of the calibrated values for all the good pixels are shown. Note that the average error is less than 0.2° C., with the maximum error 0.4° C., further confirming the validity of the method described. In FIG. 16, which comprises FIG. 16A to FIG. 16F, there is shown the measured radiometric temperature of a blackbody set at 30° C., using six different exposure times as indicated above each graph.

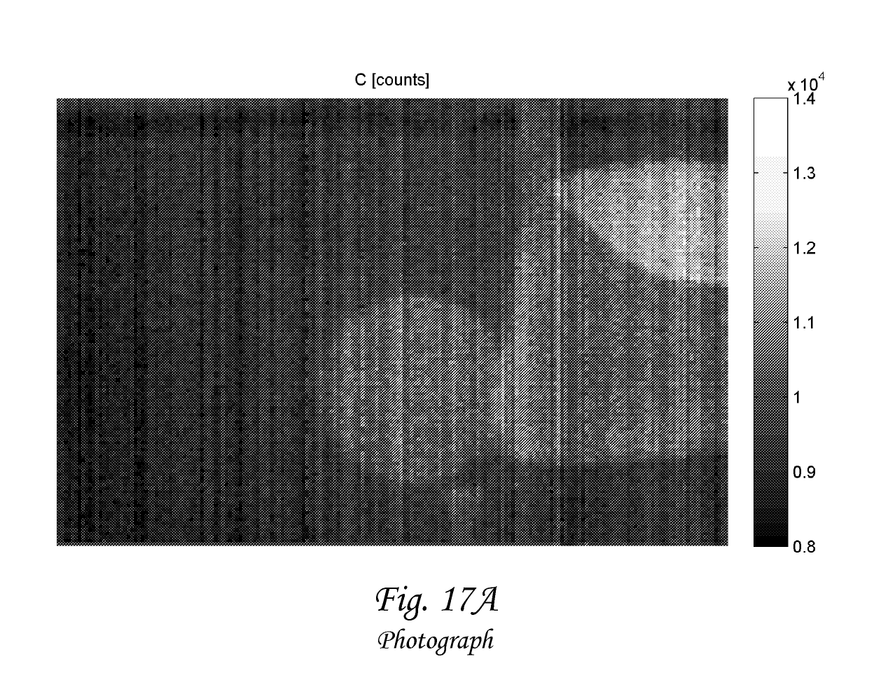

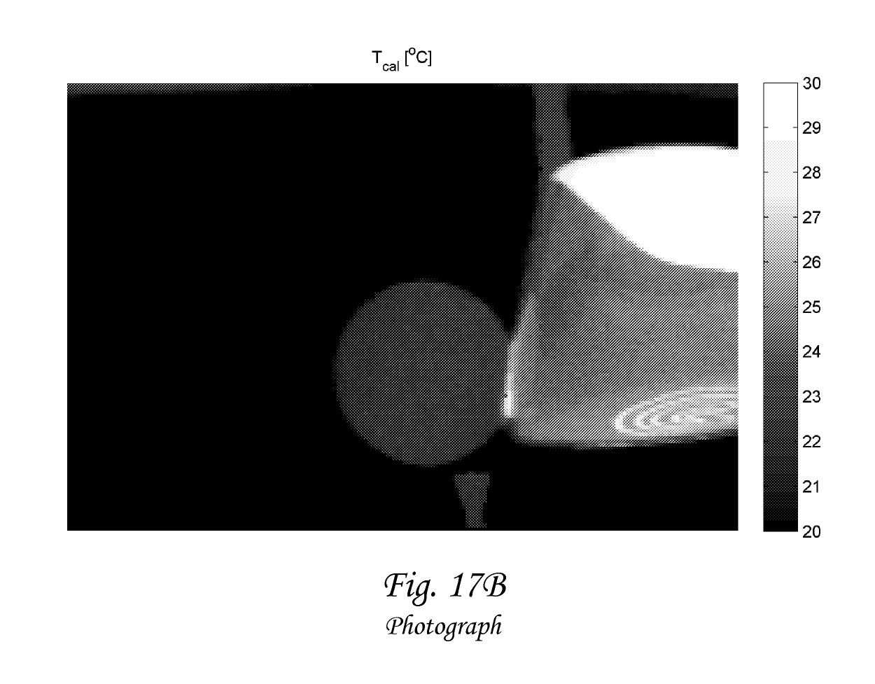

An example of data acquired with the Telops FAST-IR MW camera and calibrated with the new method is shown in FIG. 17. The image of a golf club just after hitting a golf ball off a tee is shown both for the raw uncalibrated image (FIG. 17A) and after applying the calibration process described herein, in units of radiometric temperature (FIG. 17B) obtained with the present method. Note the ˜5° C. temperature elevation at the location of the impact.

While illustrated in the block diagrams as groups of discrete components communicating with each other via distinct data signal connections, it will be understood by those skilled in the art that the illustrated embodiments may be provided by a combination of hardware and software components, with some components being implemented by a given function or operation of a hardware or software system, and many of the data paths illustrated being implemented by data communication within a computer application or operating system. The structure illustrated is thus provided for efficiency of teaching the described embodiment.

The embodiments described above are intended to be exemplary only. The scope of the invention is therefore intended to be limited solely by the appended claims.

1. A method for radiometric calibration of an infrared detector, the infrared detector measuring a radiance received from a scene under observation, the method comprising:
providing calculated calibration coefficients;
acquiring a scene count of the radiance detected from the scene;
calculating a scene flux from the scene count using the calculated calibration coefficients;
determining and applying a gain-offset correction using the calculated calibration coefficients to obtain a uniform scene flux.

2. The method as claimed in claim 1, further comprising providing an output image of said measured radiance using said uniform scene flux.

3. The method as claimed in claim 1, further comprising radiometrically transforming the uniform scene flux into a radiometric temperature using the gain-offset correction and the calculated calibration coefficients.

4. The method as claimed in claim 3, further comprising providing an output image of said measured radiance using said radiometric temperature.

5. The method as claimed in claim 3, wherein said radiometric temperature is a uniform arbitrary unit.

6. The method as claimed in claim 1, wherein said uniform scene flux is a uniform arbitrary unit.

7. The method as claimed in claim 1, wherein said infrared detector includes a set of at least one infrared lens including an infinite conjugate infrared lens for acquiring a detector image of said radiance.

8. The method as claimed in claim 7, further comprising, in the infrared detector, at least one optical filter.

9. The method as claimed in claim 8, wherein said optical filter includes a first set of at least one user-commandable bandpass spectral filters, each filter of the set for a portion of a spectral range of the infrared detector, the infrared detector further comprising a mechanism adapted to displace at least one bandpass spectral filter of said set to select a current bandpass spectral filters of said first set.

10. The method as claimed in claim 8, wherein said optical filter includes a second set of at least one user-commandable neutral density filters, each filter of the set for a signal attenuation step, the infrared detector further comprising a mechanism adapted to displace at least one neutral density filter of said second set to select a current neutral density filter of said second set.

11. The method as claimed in claim 1 wherein said providing calculated calibration coefficients comprises providing at least one calculated calibration coefficient by providing an external radiometric calibration etalon outside of said infrared detector, operating the external radiometric calibration etalon at a set of temperature setpoints spanning a range of temperatures; for each temperature setpoint of the set, acquiring at least two count values at distinct integration times; determining a curve passing through said count values at their respective integration times for each temperature setpoint of said set; identifying an intersection for all curves determined; determining the integration time origin (t_{off}) from said intersection; storing the t_{off}.

12. The method as claimed in claim 1 wherein said providing calculated calibration coefficients comprises providing at least one calculated calibration coefficient by providing a radiometric calibration etalon in front of the optical detector, measuring the radiometric calibration etalon at at least two different integration times; for each integration time, acquiring at least a count C, calculating a count origin C_{off} from said acquired counts C at their different integration times, storing C_{off}, calculating the flux value at this temperature of the radiometric calibration etalon, measuring a temperature of the radiometric calibration etalon; determining a flux shift between a laboratory acquired nominal flux curve and the dark flux value for the temperature, storing the flux shift.

13. The method as claimed in claim 7 wherein said providing calculated calibration coefficients comprises providing at least one calculated calibration coefficient by inserting a radiometric calibration etalon between the infinite conjugate infrared lens and a back end of the infrared detector, measuring the radiometric calibration etalon at at least two different integration times; for each integration time, acquiring at least a count C, calculating a count origin C_{off} from said acquired counts C at their different integration times, storing C_{off}, calculating the flux value at this temperature of the radiometric calibration etalon, measuring a temperature of the radiometric calibration etalon; determining a flux shift between a laboratory acquired nominal flux curve and the dark flux value for the temperature, storing the flux shift.

14. The method as claimed in claim 8 wherein said providing calculated calibration coefficients comprises providing at least one calculated calibration coefficient by inserting a radiometric calibration etalon between the infinite conjugate infrared lens and the optical filter, measuring the radiometric calibration etalon at at least two different integration times; for each integration time, acquiring at least a count C, calculating a count origin C_{off} from said acquired counts C at their different integration times, storing C_{off}, calculating the flux value at this temperature of the radiometric calibration etalon, measuring a temperature of the radiometric calibration etalon; determining a flux shift between a laboratory acquired nominal flux curve and the dark flux value for the temperature, storing the flux shift.

15. The method as claimed in claim 11, further comprising averaging said at least a count C, when more than one acquisition of said at least a count C, is acquired.

16. The method as claimed in claim 1 wherein said providing calculated calibration coefficients comprises inserting a radiometric calibration etalon in front of said infrared detector, measuring a radiance at the detector and a corresponding temperature of the detector while keeping a temperature of the radiometric calibration etalon constant, preparing a lookup table and providing said lookup table.

17. The method as claimed in claim 11, wherein the radiometric calibration etalon is a black body simulator.

18. The method as claimed in claim 7, further comprising performing a compensation for the variation in the offset caused by the foreoptics, including removing the foreoptics from the sensor, measuring the temperature of the sensor, observing the external radiometric calibration etalon kept at constant temperature, acquiring the signal at the sensor, and repeating the previous steps for a number of temperatures of the sensor, assessing an impact of the foreoptics on the offset at each temperature to determine an offset correction, adjusting said scene flux using said offset correction.

19. The method as claimed in claim 7, further comprising performing a compensation for the variation in the gain caused by the foreoptics, including removing the foreoptics from the sensor, measuring the temperature of the sensor, observing the external radiometric calibration etalon kept at constant temperature, acquiring the signal at the sensor, and repeating the previous steps for a number of temperatures of the sensor, assessing an impact of the foreoptics on the gain at each temperature to determine an gain correction, adjusting said scene flux using said gain correction.

20. The method as claimed in claim 1, wherein the infrared detector includes an infrared detector array.

21. The method as claimed in claim 1, further comprising obtaining at least one calibration coefficient by obtaining the nominal flux curve by providing an external radiometric calibration etalon outside of said infrared detector, operating the external radiometric calibration etalon at a set of temperature setpoints spanning a range of temperatures; for each temperature setpoint of the set, acquiring at least two count values at distinct integration times; determining a curve passing through said two count values at said distinct integration times for each temperature setpoint of said set; determining said nominal flux curve using a slope of each said curve; storing the nominal flux curve.
